(19) United States
(12) Patent Application Publication
(10) Pub. No.: US 2023/0100992 A1
(43) Pub. Date: Mar. 30, 2023

(54) SYSTEMS AND METHODS FOR AUGMENTED RECRUITING

(71) Applicant: Keeper Recruitment Corporation, Mill Creek, WA (US)

(72) Inventors: Dean Graziano, Mill Creek, WA (US); Charlie Earl Watters, III, Snoqualmie, WA (US); Derek Stanford, Bothell, WA (US); Rafael Rodrigues Alves da Rocha, Lisbon (PT)

(21) Appl. No.: 17/967,656

(22) Filed: Oct. 17, 2022

Related U.S. Application Data
(63) Continuation of application No. 16/867,369, filed on May 5, 2020.
(60) Provisional application No. 62/846,373, filed on May 10, 2019.
(60) Provisional application No. 62/904,145, filed on Sep. 23, 2019.

(51) Int. Cl. G06Q 10/10; G06F 3/0482; G06F 16/9535; G06F 16/9538

(52) U.S. Cl. CPC G06Q 10/1053; G06F 3/0482; G06F 16/9535; G06F 16/9538

(57) ABSTRACT

Systems and methods for providing augmented recruitment of candidates that connects candidates with organizations based on soft skills, expressive thoughts and content. The systems and methods create a sense of community, alleviate costs associated with recruiting, and match the best candidates with positions in which they are likely to be successful. The systems and methods utilize web-based technology that includes one or more of media capture, video sampling, peer collaboration, and text-based descriptors. Media may serve as proxy measures or representations of soft skills. A candidate may create a digital profile that includes the representations of soft skills, and may also include more traditional components used in the employment process, such as achievements and skillset. The soft skills representations may be used by recruiters or hiring managers to evaluate candidates based on their soft skills as well as their more conventionally evaluated qualifications.

### BACKGROUND

### Technical Field

The present disclosure generally relates to computer-based systems and methods and, more particularly, to computer-based systems and methods for connecting people and organizations based on content, soft skills, and expressive thoughts.

### Description of the Related Art

Recruiting is currently an inefficient process that wastes significant time and money for various reasons. Once such reason is that recruiting and hiring typically only match “hard” characteristics, such as achievements and skills, while mostly ignoring “soft” characteristics that allow the recruiter or hiring manager to really “know” the candidate and, conversely, allow the candidate to know the organization. Soft skills may include, for example, creativity, persuasion, collaboration, adaptability, time management, sense of humor, etc. In current practice, an enormous amount of time is spent reviewing resumes and transcripts, scheduling and conducting interviews based on the resumes and transcripts, and then subsequently determining that although a candidate may be qualified in terms of hard characteristics, their soft skills are not a good fit for the organization. In many instances, this determination is not made until after the candidate is employed with the organization, which results in a significant waste of time and resources for both the candidate and the organization. Thus, there is a need to provide improved systems and methods for connecting people and organizations, such as candidates and employers, in a way that provides significantly better matches, which reduces or eliminates the inefficiencies of current practices.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram illustrating an augmented recruitment system and an environment in which the augmented recruitment system may operate, according to one illustrated implementation.

FIG. 2 is an example attribute representation creation interface of the augmented recruitment system, according to one illustrated implementation.

FIG. 3 is an example visual content selection interface of the augmented recruitment system, according to one illustrated implementation.

FIG. 4 is an example profile creation interface of the augmented recruitment system, according to one non-limiting illustrated implementation.

FIG. 5 is an example candidate digital profile for a candidate of the augmented recruitment system, according to one non-limiting illustrated implementation.

FIG. 6 is a logical flow diagram generally showing one embodiment of a process for generating a digital candidate-personality profile, according to one non-limited illustrated implementation.

FIG. 7 is a logical flow diagram generally showing one embodiment of a process for augmenting a job application based on a digital candidate-personality profile, according to one non-limited illustrated implementation.

FIG. 8 is a logical flow diagram generally showing one embodiment of a process for generating a team-personality profile, according to one non-limited illustrated implementation.

FIG. 9 is an example employee digital profile for an employee, according to one non-limiting illustrated implementation.

FIG. 10 is a block diagram of a data fusion subsystem of the augmented recruitment system, according to one non-limiting illustrated implementation.

FIG. 11 is a block diagram of a data analytics subsystem of the augmented recruitment system, according to one non-limiting illustrated implementation.

FIG. 12 is a block diagram of an example processor-based device that may be used to implement at least a portion of the augmented recruitment system or other system of the present disclosure, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to systems and methods that provide improved functionality for recruitment, hiring and onboarding of candidates for organizations (e.g., employers). In at least some implementations, the systems and methods may utilize web-based technology that includes one or more of media capture, video sampling, peer collaboration, and text-based descriptors. Visual media may serve as proxy measures or representations of soft skills, such as leadership, problem solving, teamwork, communication, interpersonal, flexibility/adaptability, work ethic, etc. A candidate, also referred to herein as a user, applicant, employee, employer, or job-seeker, may create a digital business card profile (or “digital profile”) that includes representations of soft skills. The digital business card profile may also include more traditional components used in the employment process, such as resumes, transcripts, letters of recommendation, etc. In at least some implementations, the user may be able to manage and maintain their digital business card profile for an extended period of time, such as throughout their employment career.

The soft skills representations selected by individual candidates may be used by recruiters or hiring managers to evaluate candidates based on their soft skills as well as their more conventionally evaluated qualifications, such as achievements and skillset. In at least some implementations, peer-sourcing may be used to capture the soft skills measures of a candidate. For example, those familiar with the candidate may select content representative of the candidate, or may otherwise weigh-in on content previously selected by or associated with the candidate. In at least some implementations, the system may provide one or more indicators of the candidate's credibility. Such indicator may include one or more values (e.g., numerical score, grades), one or more profile summaries or statistics, one or more comparisons to other candidates, or any other measures that may be indicative of a candidate's credibility, aptitude, or other metric. In at least some implementations, the system may utilize machine learning to provide valuable insights and trend information regarding selected content, the cultural tenor or pulse of the work unit or organization, or tenure and success measures.

The systems and methods of the present disclosure advantageously create a sense of community, alleviate costs to recruit and attract individuals, and get to the root of hiring problems by matching only the best candidates with the best likelihood of succeeding at specific roles. Additionally, the systems and methods discussed herein may be used to provide or enhance social networks, or may be used to identify future available positions for candidates based on previously supplied or learned information about the candidates or available positions. Although many embodiments are discussed in terms of job candidates and hiring, embodiments are not so limited. The systems and methods discussed herein may also be used in the context of employees and team dynamics, dating and relationships, education and living arrangements, and other situations where identifying and correlating soft skills can provide useful information.

In at least some implementations, content may be selected or identified by the candidate or on behalf of the candidate (e.g., peer-sourcing). Similarly, an organization may submit content, identify (e.g., “like”) content, or directly or indirectly provide information indicative of the organization's desired content or soft skills. In at least some implementations, the system may learn or identify the soft skills attractive to an organization by autonomously analyzing information associated with the organization, such as publically available information (e.g., website, social media, job descriptions) or information provided by the organization.

In at least some implementations, the system may tap into incoming job applications for organizations received from multiple sources (e.g., Indeed, LinkedIn, etc.). Advantageously, this may be achieved by seamlessly monitoring all incoming email applications regardless of source, and augmenting the sourcing and interviewing process with the digital profiles. For candidates that have already created digital profile, the system may automatically send a link to access the digital profile to the organization responsive received of the monitored email that includes the candidates application. For candidates that do not yet have a digital profile, the augmented recruitment system may automatically send the candidate a link to create a digital profile to complete their job application. Once the candidate creates the digital profile, the augmented recruitment system may automatically send a link to the digital profile to the recruiter or hiring organization for review. Thus, advantageously, organizations are able to review the candidates' digital profiles without modifying their existing recruitment workflow.

As a non-limiting example, a hiring organization may send an email to each recruiter assigned to a job with the applicant information, job ID, job title, and the applicant's resume, whether it comes from their company site, LinkedIn, Indeed, etc. The augmented recruitment system may provide a custom email address for use by the hiring organization. The augmented recruitment system then “listens” when it receives an email of new application. Upon receipt of the new email, the augmented recruitment system may use the candidate's email address to match against existing user accounts of the augmented recruitment system. If there is a match, the augmented recruitment system immediately replies to the email thread with the link to the candidate's digital profile page for review by the recruiter or hiring manager.

If the candidate does not yet have a digital profile page on the augmented recruitment system, the augmented recruitment system may not send the recruiter a reply until the candidate completes their digital profile. In such instances, the augmented recruitment system may first create an starting digital profile for the candidate using as much information that is available, such as the candidate's first name, last name, an upload of the resume attached to the application, social links, or other information that the augmented recruitment system can automatically obtain from the email body or attachments (e.g., resume, transcripts, writing samples) with confidence. The augmented recruitment system may then email the candidate to invite them to complete their digital profile which has already been partially created automatically. The augmented recruitment system may monitor for completion of the digital profile by that candidate and, once complete, the augmented recruitment system may automatically reply to the original email the recruiter received with a link to the candidate's newly created digital profile.

In at least some implementations, the augmented recruitment system may include a section that identifies (e.g., with logos) company names of a subset or all participating companies that includes links to such companies' career pages. This feature functions to drive traffic to the companies' sites, giving the candidate a faster way to share who they are, with more companies, quickly, and within context of learning each company with their own marketing/branding/career pages, etc.

These and other features are discussed further below with reference to the drawings.

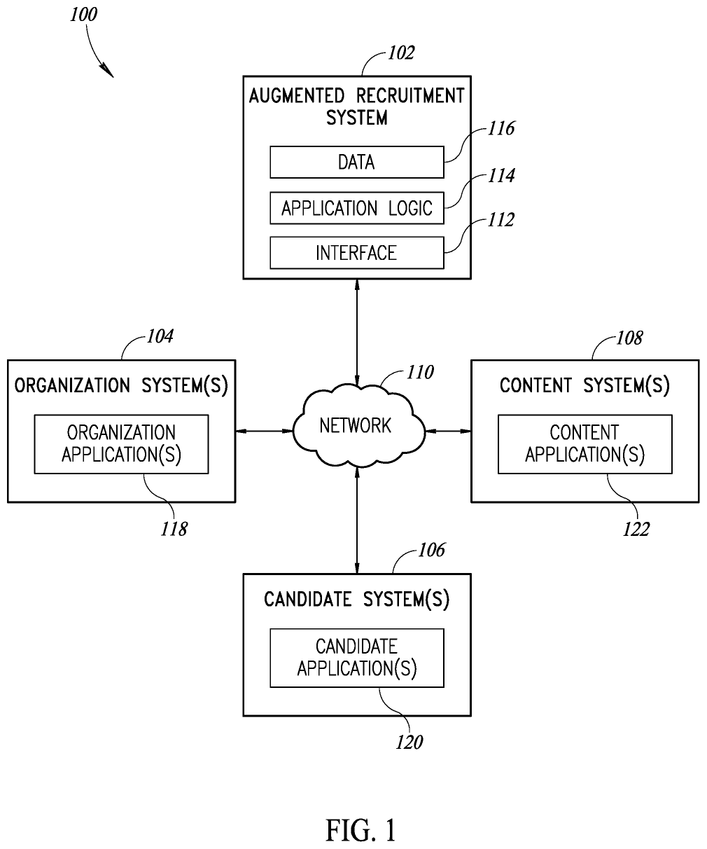

FIG. 1 is a diagram that illustrates an environment 100 in which an augmented recruitment system 102 of the present disclosure may operate. The augmented recruitment system 102 may interact with various other systems, such as hiring organization systems 104, candidate systems 106, content source systems 108, etc., over a network 110 (e.g., the Internet).

As a non-limiting example, the augmented recruitment system 102 may be generally organized in a three layer architecture that includes an interface layer 112, an application logic layer 114, and a data layer 116. Each component in FIG. 1 may represent a set of executable instructions and corresponding hardware, such as memory and processor(s), for executing the instructions, thereby forming hardware-implemented components operating as a special-purpose machine that performs a particular set of functions. For the sake of brevity, various functional components that are not necessarily important for providing an understanding of the subject matter of the present disclosure have been omitted. However, additional or fewer components may be used with the augmented recruitment system to provide various functionality. Furthermore, the various components may be implemented in a single computing system or device (e.g., server computer, client device), or may be distributed across several computers in numerous configurations.

The interface layer 112 may include interface components, such as a web server, which receive requests from client computing devices and servers, such as organization system 104 executing organization application 118, candidate system 106 executing candidate applications 120, or content system 108 executing content applications 122. In response to received requests, the interface 112 may communicate appropriate responses to requesting systems via the network 110. For example, the interface 112 may receive Hypertext Transfer Protocol (HTTP) requests, or other web-based, Application Programming Interface (API) requests.

The candidate system 106 may execute web browser applications or platform-specific applications (“apps”). For example, the candidate system 106 may interact with the augmented recruitment system 102 via a web browser, an iOS® app, an Android® app, etc. Additionally, in at least some implementations, the candidate system 106 may perform some or all of the functionality of the augmented recruitment system 102. Generally, the candidate system 106 may include a device that includes a display and a communication interface that allows the candidate system to communicate with the augmented recruitment system 102 and other systems via the network 110. The candidate system 106 may include, for example, a personal computer, a smartphone, a wearable computer, a tablet computer, a personal digital assistant (PDA), a laptop computer, a desktop computer, a game console, a set-top box, etc.

The data layer 116 may include a database server that facilitates access to information storage units such as one or more databases. The databases may store various data, such as candidate digital profile data, visual content data, textual data, event data, and other types of data.

The application logic layer 114 may include various application logic components which interact with the interface layer 112 and data layer 116 and implement some or all of the various functionality described herein. For example, the application logic 114 may include logic to facilitate the creation of device profiles, accessing content from content source systems 108 (e.g., systems operated by content providers), communicating with organization systems 104 (e.g., systems operated by hiring organizations, job posting organizations, etc.).

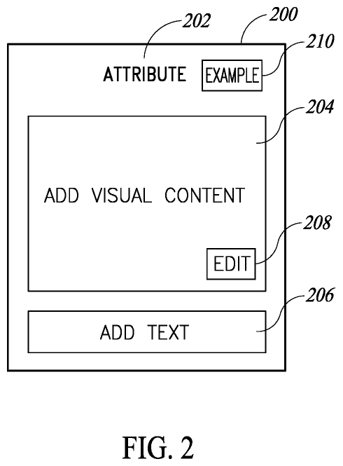

FIGS. 2-5 show various example interfaces of the augmented recruitment system 102 of FIG. 1 that may be provided to allow the creating and viewing of candidate digital profiles. The interfaces are provided as examples of the functionality provided by the augmented recruitment system 102, and it should be appreciated that variations of the interfaces may be provided for different implementations or for different platforms (e.g., web browser versions versus mobile app versions). As discussed above, candidates may be prompted to generate a device profile automatically responsive to a candidate applying for a position at an organization via monitoring of the emails received from candidates. Candidates may also generate digital profiles independent of applying for a position. For example, a candidate may create a digital profile so that when they subsequently apply for positions, the digital profile will be immediately sent to the hiring organization. As another example, a candidate may create a digital profile so that hiring organizations or other entities may search for and view their digital profile and contact the candidate regarding potential opportunities. The candidate may also provide links to the created digital profile on various applications or services, such as one or more social media, networking, or job posting applications.

FIG. 2 shows an example attribute representation creation interface 200 of the augmented recruitment system 102 of FIG. 1, according to one illustrated implementation. The attribute representation creation interface 200 may be provided to a candidate responsive to the candidate indicating that they want to generate a new digital profile. In at least some implementations, an instance of the attribute representation creation interface 200 may be provided for each of a plurality of attributes that the augmented recruitment system captures or represents for the candidate when generating the digital profile. The number of attributes to be represented for a digital profile may be fixed (e.g., 2, 4, 8, or 20 attributes), or may be variable (e.g., determined by the candidate, determined by the organization, etc.). In some implementations, candidates may be able to select M number of attributes to capture out of a total of N number of attributes, where M is less than or equal to N. In some implementations, candidates may be able to represent new attributes that are not already included for selection in the augmented recruitment system.

Non-limiting examples of attributes that may be captured in a digital profile by the augmented recruitment system include sense of humor, attitude on life, activities, something inspiring, something creative, “show me something I may not know,” “show me something new,” “show me something unusual,” bucket list, your happy place, theme song, risk versus reward, “if you were a movie (or other something), what would you be?”, etc.

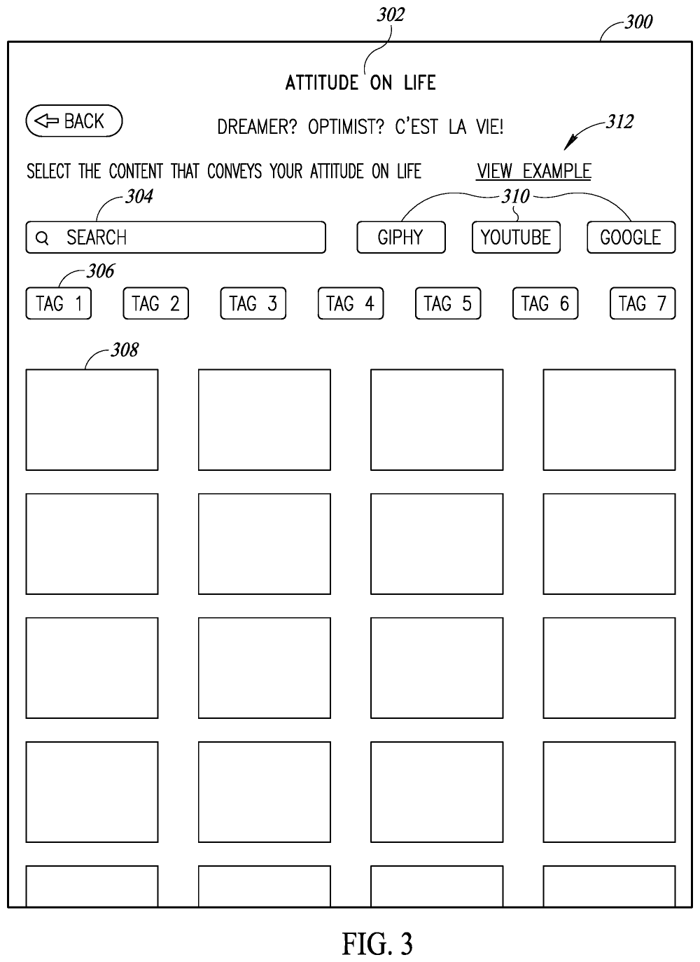

The attribute representation creation interface 200 displays the attribute name 202, and also includes a visual content window 204 which allows the candidate to add visual content for the attribute, and an add text window 206 for the candidate to add a textual descriptor that relates to the selected visual content or the attribute. To add visual content for the attribute, the candidate may select an edit button 208 positioned inside the visual content window 204, which causes a visual content selection interface 300 (FIG. 3) to be presented. To add a text descriptor, the candidate may select (e.g., click on, tap) the add text window 206. In some instances, the text descriptor may be limited to a determined length (e.g., 140 characters, 200 characters, 100 words). Further, in at least some implementations, the attribute representation creation interface 200 may alternatively or additionally include an interface that allows the user to select audio content, such as a song, a podcast, a poetry reading, etc. The attribute representation creation interface 200 may allow the user to create non-textual content to include in the attribute representation. Such content may include visual content (e.g., a drawing, an image, a video) or audio content (e.g., a statement, a song, a reading).

To assist candidates that are creating a digital profile for the first time, the attribute representation creation interface 200 may also include an example button 210 which, upon selection, presents an example attribute representation to the candidate that includes an example selected visual content and an example text descriptor. The provided example may be specific to the attribute currently being represented, or may be a common example for all attributes.

FIG. 3 is an example visual content selection interface 300 of the augmented recruitment system 102. As an example, the visual content selection interface 300 may be presented to the candidate responsive to selection of the edit button 208 on the attribute representation creation interface 200. The visual content selection interface 300 includes a title 302 that indicates the attribute to be represented. In this example illustration, the attribute is “attitude on life.” The visual content selection interface 300 also includes a search bar 304 that allows candidates to input text to be searched for in one or more visual content databases, and search results 308 may be presented to the candidate below the search bar. The visual content selection interface 300 may also include tags 306 that are generated based on the input text which allow the user to refine their search to include results that are associated with one or more selected tags. In some implementations, the visual content selection interface 300 may include content source selection buttons 310 that allow the candidate to specify one or more content sources (e.g., GIPHY, YouTube, Google) to be searched.

The candidate may select one of the results 308 to be used as the visual content for the attribute on the candidate's digital profile. To create a complete digital profile, the candidate may select visual content and add a text descriptor for each of a plurality of attributes that are to be represented.

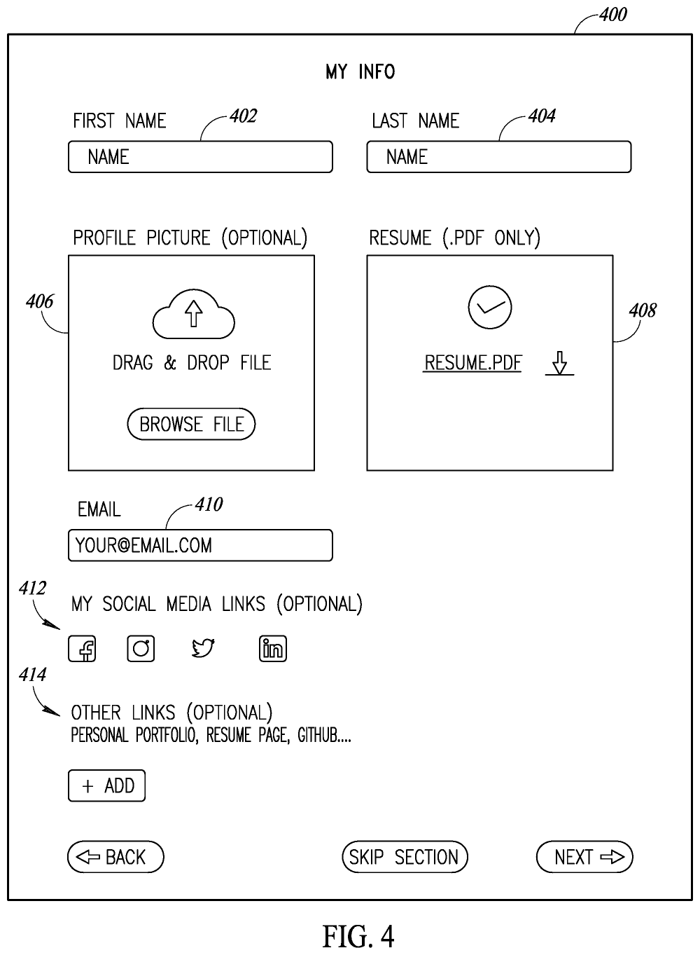

FIG. 4 is an example profile creation interface 400 of the augmented recruitment system 102. The profile creation interface 400 may be presented to the candidate before or after the candidate generates the attribute representations through the attribute representation creation interface 200 and the visual content selection interface 300. As discussed above, at least a portion of the content in the profile creation interface 400 may be automatically completed based on an analysis of the candidate's original job application email and attachments.

The profile creation interface 400 includes text boxes 402 and 404 that allow the candidate to input their first and last names, respectively. The profile creation interface 400 also includes a profile picture upload interface 406 that allows a candidate to optionally upload a profile picture to include in their digital profile. The profile creation interface 400 further includes a resume upload interface 408 that allows the candidate to upload their resume in one or more formats (e.g., PDF, Word, text). An email input box 410 is also provided to allow the candidate to input their email address.

The profile creation interface 400 may also include an optional social media link interface 412 that allows the candidate to link to one or more of their social media profiles (e.g., Facebook, LinkedIn, Twitter). The profile creation interface 400 may also include an optional other links interface 414 that allows the candidate to link to other resources or to upload additional documents. For example, the candidate may link to a personal portfolio, a resume page, a GitHub page, or may upload additional documents such a transcripts, work product samples, letters of recommendation, etc.

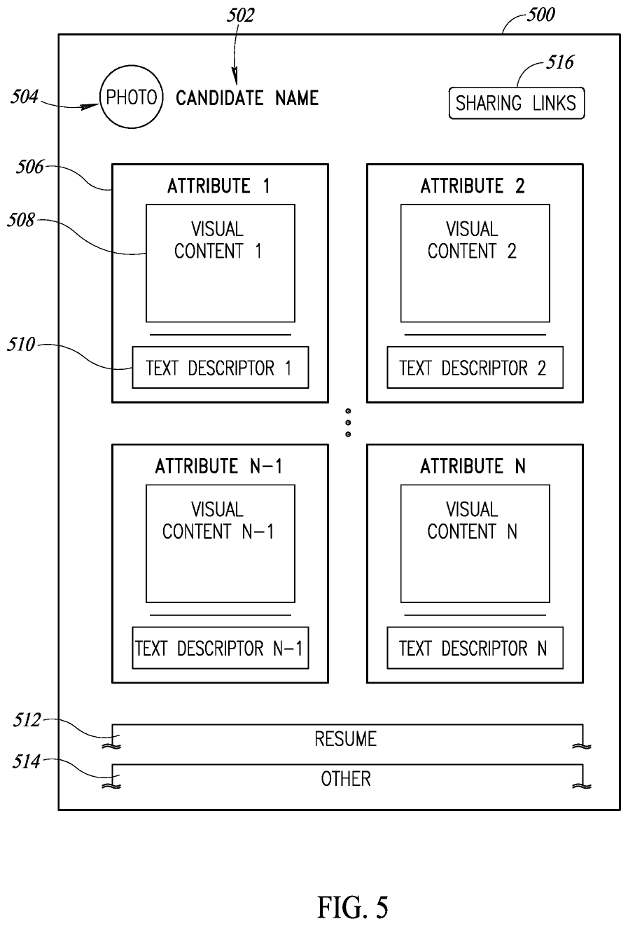

FIG. 5 is an example candidate digital profile 500 for a candidate of the augmented recruitment system. The candidate digital profile 500 may be accessible via a static link that may persist for an extended period of time, such as throughout a candidate's career. Recruiters and hiring managers may access the candidate digital profile 500 via the link, and the candidate may share the link in various ways, such as email, social media sites, job posting sites, etc.

The candidate digital profile 500 displays the candidate name 502 and optionally a photo 504 of the candidate. The candidate digital profile 500 also includes a number N (e.g., 2, 4, 10, 20) of attribute representations 506 that each correspond to a particular attribute, as discussed above. Each attribute representation 506 includes selected visual content 508 and a generated text descriptor 510 for the visual content/attribute. Below the attribute representations 506, the candidate digital profile 500 may also the candidate's resume 512 and other content 514. As noted above, the other content may include links to other resources (e.g., portfolio) or copies of one or more documents (e.g., transcripts, letters of recommendation).

In at least some implementations, the augmented recruitment system may allow the candidate to edit the candidate digital profile. The augmented recruitment system 102 may allow the candidate to reorder the presentation of the attribute representations and to “hide” selected attribute representations to customize their digital profile page. In at least some implementations, the candidate may save one or more customized profile pages, and may have a global or default profile page that includes all of the attribute representations in a specified order.

In at least some implementations, a recruiter may add curation on a candidate's profile page to present the best view of the candidate to a hiring manager. Such may include reordering attributes, hiding attributes, anonymizing or not anonymizing the candidate's resume or other information, adding custom text notes to the hiring manager on the profile page, customizing the layout, etc. This feature may create separate instances of the candidate's profile page, with unique links, that are all associated with the same candidate record. In some instances, a recruiter may create N links for a candidate's profile page, but by default there is the “global” revealed profile page, and a default “anonymous” profile page.

As noted above, the augmented recruitment system may allow a recruiter (or other entity) to present a candidate's digital profile page anonymously or non-anonymously. This feature may advantageously reduce bias in the recruiting process.

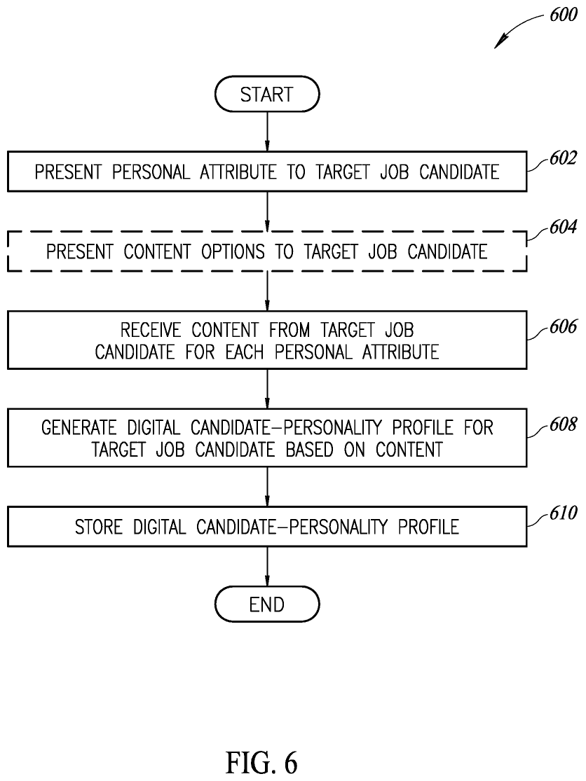

The operation of certain aspects of the disclosure will now be described with respect to FIGS. 6-8. In at least one of various embodiments, processes 600, 700, or 800 described in conjunction with FIGS. 6-8, respectively, may be implemented by or executed on one or more computing devices, such as processor-based device 1200 in FIG. 12 or other computing systems.

FIG. 6 is a logical flow diagram generally showing one embodiment of a process 600 for generating a digital candidate-personality profile, according to one non-limited illustrated implementation.

Process 600 begins, after a start block, at block 602, where one or more personal attributes are presented to a target job candidate. As discussed herein, an attribute representation creation interface 200 in FIG. 2 may be displayed to the target job candidate, which requests the target job candidate to provide content for various personal attributes. Examples of such attributes include, but are not limited to, sense of humor, attitude on life, activities, something inspiring, something creative, “show me something I may not know,” “show me something new,” “show me something unusual,” bucket list, your happy place, theme song, risk versus reward, “if you were a movie (or other something), what would you be?”, etc. The personal attributes that are presented to the target job candidate may be selected by a hiring supervisor, administrator, associated with a job application, associated with a target employer, or even selected by the target job candidate.

Process 600 proceeds to block 604, where content options are presented to the target job candidate. In various embodiments, one or more of the personal attributes presented to the target job candidate may include a plurality of content options from which the target job candidate can select. The content options may be images, text, audio or video clips, links, etc., or some combination thereof, and may be pre-selected by the hiring supervisor, administrator, etc.

In some embodiments, the content options may be selected based on an associated job or employer. For example, if the personal attribute is something inspiring and the job is for a hiking guide, the content options may include photos of various landscapes throughout the world. Conversely, if the job is for a teacher, then the content options may include quotes from famous people dealing with the education system.

In some scenarios and embodiments, block 604 may be optional and may not be employed.

Process 600 continues at block 606, where content is received from the target job candidate for each personal attribute. The received content may include images, text, video, audio, links, or some combination thereof. In some embodiments, the target job candidate selects the content from the content options presented to the target job candidate at block 604. In other embodiments, the target job candidate manually selects the content, which may include uploading content from a personal computing device or searching a database (e.g., an internet search engine) for content.

Process 600 proceeds next to block 608, where a digital candidate-personality profile is generated for the target job candidate. In various embodiments, the digital candidate-personality profile includes the content selected or provided by the target job candidate, a resume for the target job candidate, a photo of the target job candidate, transcripts, or other information.

In various embodiments, the digital candidate-personality profile may include metrics generated based on the selected content. For example, in some embodiments, the content may be run through an artificial intelligence model that is trained using a plurality of pre-selected or sample content. The output of the artificial intelligence model may be a content score for the target job candidate. When the target job candidate applies for a target job, the content score for the target job candidate can be compared to a base metric for a target job. For example, a supervisor of the target job can select content for the same attributes, which, when run through the artificial intelligence model, generates a baseline score for the target job. If the target job candidate's content score is within a select threshold value or percentage of the baseline score, then that target job candidate may be identified as being a good personality fit for the target job or team associated with the target job, whereas a content score that exceeds the threshold value or percentage of the baseline score, then the target job candidate may be identified as not being a good personality fit for the target job or team.

Process 600 continues next at block 610, where the digital candidate-personality profile is stored in a database with other profiles for other job candidates. In various embodiments, a link to the digital candidate-personality profile may be sent to the target job candidate, such as in an email or text. In this way, the target job candidate can provide the link to potential employers, such that the potential employers can access the target job candidate's profile.

In various embodiments, the target job candidate can dynamically update the content selected for one or more attributes. Likewise, a recruiter can dynamically change, remove, or add attributes. When an attribute is changed or added, the target job candidate may be notified of the change and requesting to update their digital candidate-personality profile. In this way, the target job candidate's digital candidate-personality profile can be updated and assessed when the candidate or job parameters or job requirements change over time.

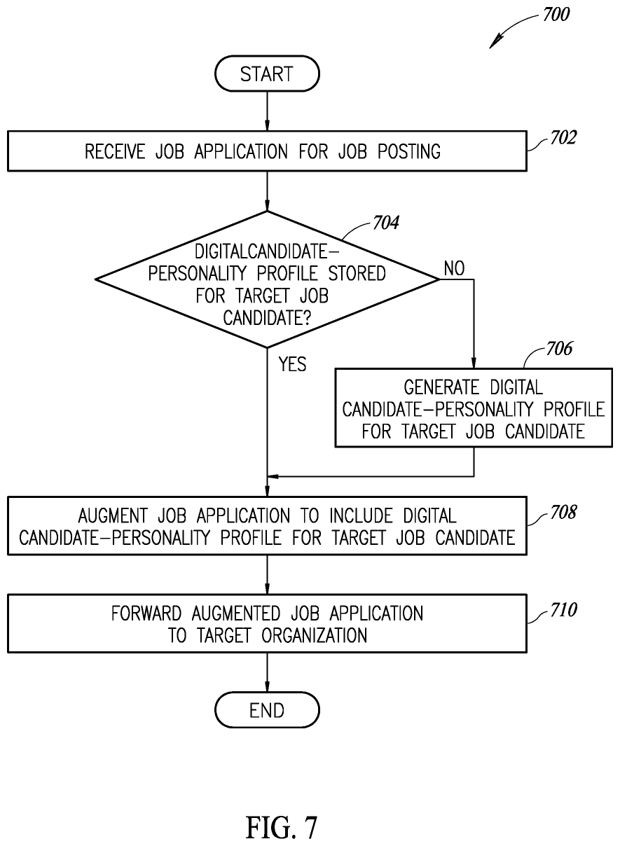

FIG. 7 is a logical flow diagram generally showing one embodiment of a process 700 for augmenting a job application based on a digital candidate-personality profile, according to one non-limited illustrated implementation.

Process 700 begins, after a start block, at block 702, where a job application from a target job candidate is received for a job posting. In some embodiment, the target job candidate may submit the job application to the system to be augmented with the target job candidate's digital candidate-personality profile. In other embodiments, the target organization of the job posting may have received the job application from the target job candidate. In this case, the target organization may submit the job application to the system to be augmented with the target job candidate's digital candidate-personality profile.

Process 700 proceeds to decision block 704, where a determination is made whether a digital candidate-personality profile is stored for the target job candidate. In at least one embodiment, the job application may include a link or profile identifier indicating that a digital candidate-personality profile has been generated and stored for the target job candidate. In other embodiments, the system may query a database of digital candidate-personality profiles using the target job candidate's name, birthdate, or other identifying information.

If a digital candidate-personality profile is stored for the target job candidate, then process 700 flows to block 708; otherwise, process 700 flows to block 706.

At block 706, a digital candidate-personality profile is generated for the target job candidate, which is discussed above in conjunction with process 600 in FIG. 6. After block 706, or if the digital candidate-personality profile for the target job candidate was previously stored, then process 700 flows to block 708.

At block 708, the job application is augmented to include the digital candidate-personality profile for the target job candidate, or a portion thereof. In some embodiments, the job application is modified to include a link to the digital candidate-personality profile. In other embodiments, the job application is modified to include information from the digital candidate-personality profile. For example, in some embodiments, the job application may be modified to include one or more of the attributes and candidate-selected content from the digital candidate-personality profile. In yet other embodiments, the job application may be modified to include one or more metrics or scores generated for the target job applicant based on the content selected for the attributes. Process 700 proceeds next to block 710, where the augmented job application is forwarded to a target organization. The target organization may be the company hiring for the job posting, a recruiter, a third party job posting service, etc.

After block 710, process 700 may terminate or otherwise return to a calling process to perform other actions.

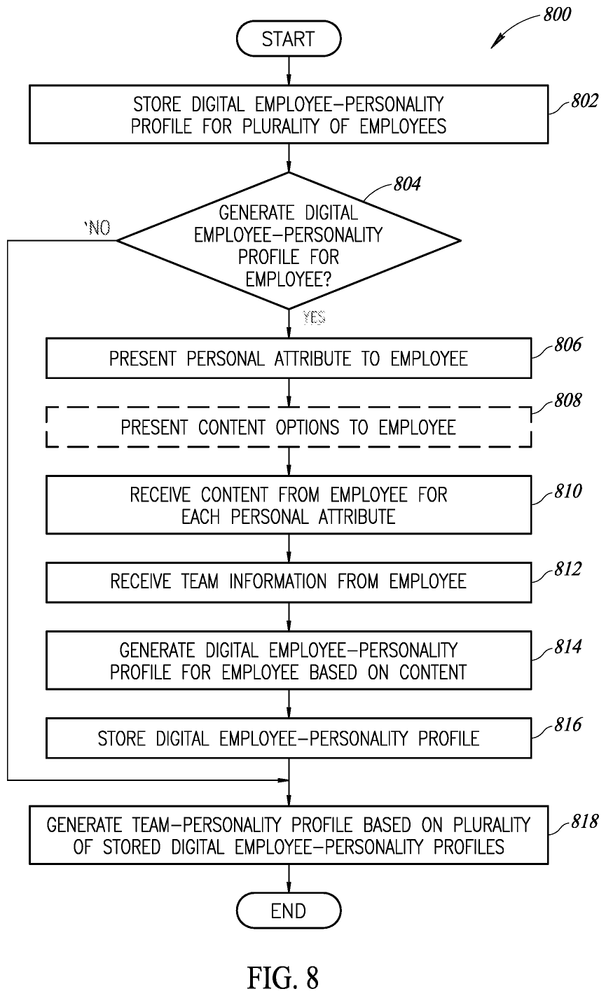

Although embodiments described above are primarily directed to job seekers, embodiments are not so limited. Rather embodiments described herein can be used to assess team and employee compatibility. For example, FIG. 8 is a logical flow diagram generally showing one embodiment of a process for generating a team-personality profile, according to one non-limited illustrated implementation.

Process 800 begins, after a start block, at block 802, where digital employee-personality profiles are stored for a plurality of employees of an organization. In various embodiments, digital employee-personality profiles for employees may be generated by employing embodiments of blocks 806, 808, 810, 812, 814, and 816 described below.

Process 800 proceeds to decision block 804, where a determination is made whether a digital employee-personality profile is to be generated for an employee. In some embodiments, this determination is made by an employee providing input indicating that the employee intends to generate a digital employee-personality profile. In other embodiments, a manager or supervisor may request that the employee generate a digital employee-personality profile. In at least one such embodiment, a link or invite may be sent to the employee requesting the employee to generate the digital employee-personality profile. If a digital employee-personality profile is to be generated for the employee, process 800 flows to block 806; otherwise process 800 flows to block 818.

At block 806, one or more personal attributes are presented to the employee. In various embodiments, block 806 may employ embodiments of block 602 in FIG. 6 to present attributes to the employee.

Process 800 proceeds to block 808, where content options are presented to the employee. In various embodiments, block 808 may employ embodiments of block 604 in FIG. 6 to present content options to the employee. In some embodiments, block 808 may be optional and may not be performed.

Process 800 continues at block 810, where content is received from the employee for each of the one or more personal attributes. In various embodiments, block 810 may employ embodiments of block 606 in FIG. 6 to receive content from the employee.

Process 800 proceeds next to block 812, where team information is received from the employee. In various embodiments, the employee may enter a manager name, a group name, a division name, or some other team identifying information. The team information may be company-wide or it may be for a small group of people that are working on a project together or any size in between. In some embodiments, the employee may also provide their role in the team, such as employee, member, manager, executive, etc.

Process 800 continues next at block 814, where a digital employee-personality profile is generated for the employee based on the content received from the employee. In various embodiments, block 814 may employ embodiments of block 608 in FIG. 6 to generate the digital employee-personality profile. The digital employee-personality profile may also include the team information provided by the employee.

Process proceeds to block 816, where the digital employee-personality profile is stored with the other digital employee-personality profiles for the plurality of employees. In some embodiments, block 816 may employ embodiments of block 610 in FIG. 6 to store the digital employee-personality profile.

After block 816, or if it is determined at decision block 804 to not generate a digital employee-personality profile, process 800 proceeds to block 818. At block 818, a team-personality profile is generated based on the plurality of stored digital employee-personality profiles. In some embodiments, an employee, manager, executive, etc. may be presented with a dashboard or other graphical user interface showing details of one or more teams based on the plurality of stored digital employee-personality profiles. The digital employee-personality profiles for a particular team can be run through an artificial intelligence or machine learning model that is trained to identify correlations among the content selected by the team members for each attribute. The team-personality profile can identify these correlations, track the impact of changes when team members are added or removed from the team (e.g., by re-running the trained model with the digital employee-personality profiles of the updated team), etc. Moreover, the team personality profile can dynamically change or be updated as employees update their digital employee-personality profiles to include new or changed content, select content for newly added personality attributes, etc.

In various embodiments, the team-personality profile may track trends of attributes and content over time to determine how teams change and where problems or opportunities may arise in improving team moral or dynamics. In some embodiments, other machine learning mechanisms or algorithms may be employed to build models that predict such team changes.

In various embodiments, the team-personality profile may indicate or identify employees that share similar personality traits, share common interest or hobbies, or those that may conflict with one another. In some embodiments, employees that share similar personality traits or common interests or hobbies may be put into contact with one another or provided with events or opportunities to participate in the shared interest, which may create or improve team bonds or create affinity groups or provide mentoring opportunities. In other embodiments, a manager may be notified if multiple employees have personality traits that conflict with one another. In this way, the manager can prevent conflicts or take remedial action to reduce tension or issues in the team or identify areas where team building may be needed.

In various embodiments, employees can dynamically update the content selected for one or more attributes. Likewise, a manager or supervisor can dynamically change, remove, or add attributes. When an attribute is changed or added, the employees may be notified of the change and requesting to update their digital employee-personality profile. In this way, the team personality can be updated and assessed when employees or team goals or duties change over time.

Depending on the size of the team (e.g., company-wide v. division v. group project) and the team member, the team-personality profile may provide different information to different members. For example, individual members may be able to assess how they compare to other members of the team or to the whole company. Comparatively, a manager may be able to identify what motivates their team, what does the team want or like to do, or even how to encourage team work among members. Moreover, the manager may be able to compare their team dynamics to other teams of the company. Executives can also utilize the team-personality profiles to determine which teams are similar or different, what characteristics or combinations of characteristics are important or predicative or productive, what motivates teams or members, how to better structure teams, etc.

After block 818, process 800 terminates or otherwise returns to a calling process to perform other actions.

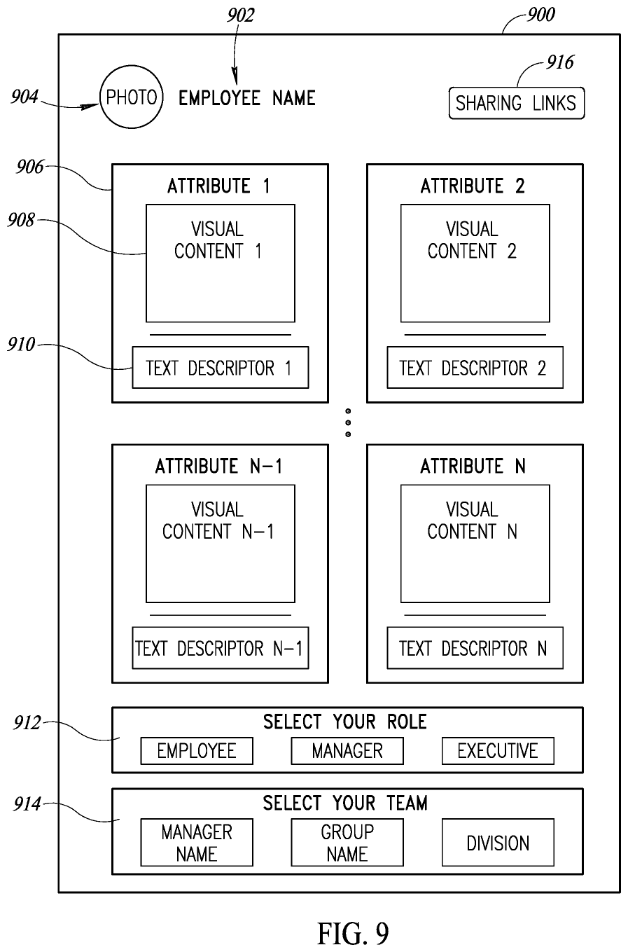

FIG. 9 is an example employee digital profile 900 for an employee, according to one non-limiting illustrated implementation. The employee digital profile 900 may be accessible via a static link that may persist for an extended period of time, such as throughout an employee's career. Managers may access the employee digital profile 900 via the link, and the employee may share the link in various ways, such as email, social media sites, intranet billboards, etc. In some embodiments, a team-personality profile may include the links to the employee digital profiles 900 of each team member.

The employee digital profile 900 displays the employee name 902 and optionally a photo 904 of the employee. The employee digital profile 900 also includes a number N (e.g., 2, 4, 10, 20) of attribute representations 906 that each correspond to a particular attribute, as discussed above. Each attribute representation 906 includes selected visual content 908 and a generated text descriptor 910 for the visual content/attribute. As noted above, the attribute representation 906 may include images, audio, text, graphics, video, etc. and are not limited to the visual content and text descriptor shown. Below the attribute representations 906, the employee digital profile 900 may also a role section section 912 and a team selection section 914. The role selection section 912 may include a plurality of buttons or other selection options in which the employee indicates their role in the team or in the organization. The team selection section 914 may include a plurality of buttons, dropdown menus, or text input boxes in which the employee can identify the team or teams in which they are a member.

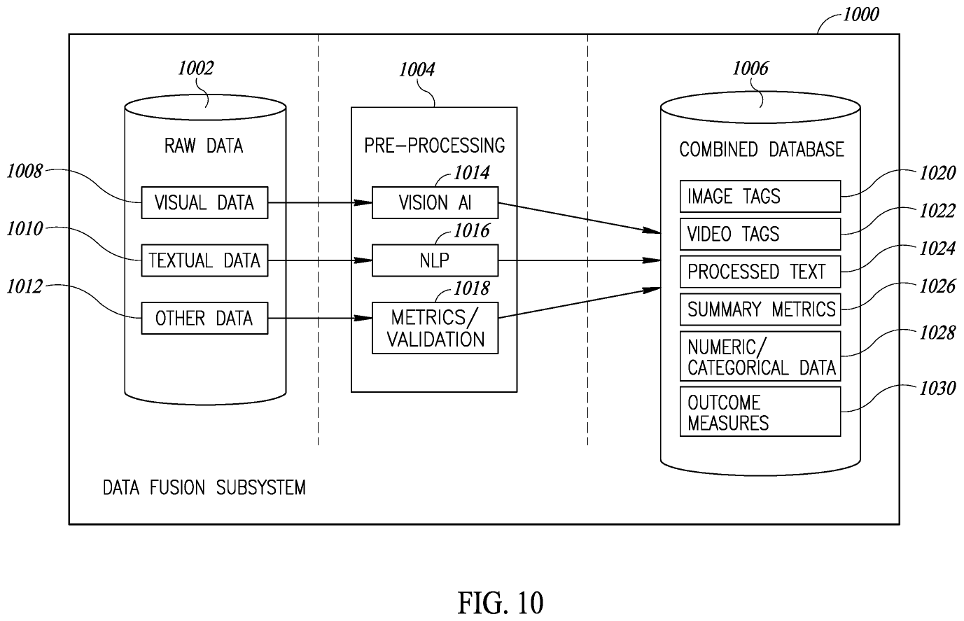

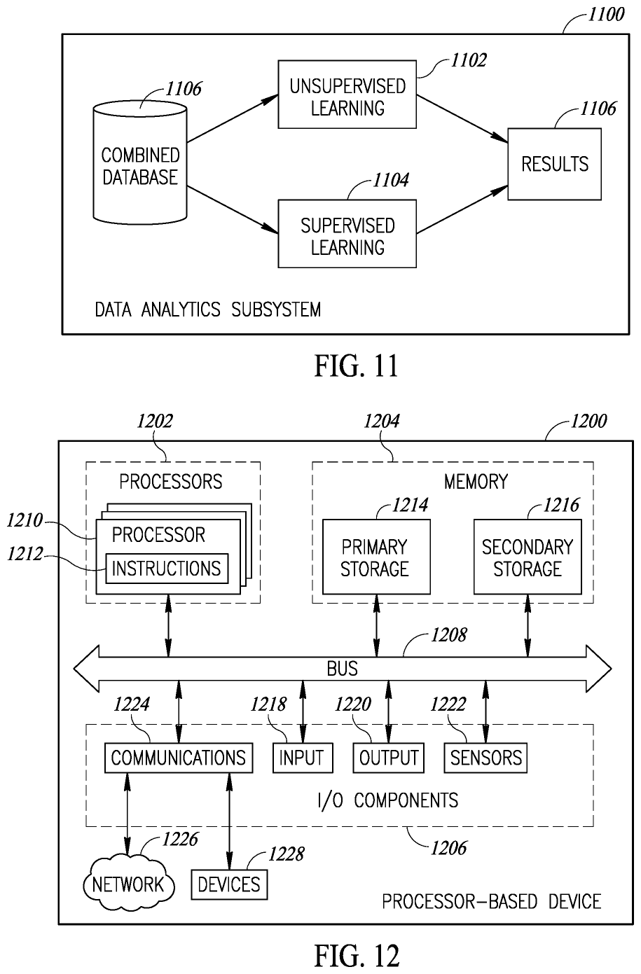

FIG. 10 is a block diagram of a data fusion subsystem 1000 of the augmented recruitment system 102, and FIG. 11 is a block diagram of a data analytics subsystem 1100 of the augmented recruitment system. The data fusion subsystem 1000 and the data analytics subsystem 1100 may be used to provide important insight to both job-seekers and hiring professionals.

For example, in at least some implementations multiple data analysis concepts are combined, such as data fusion (e.g., drawing from several disparate data sources), the use of Natural Language Processing (NLP) methods to identify key concepts in a document database, an interface which collects feedback from users, and predictive models based on all of the above to prioritize job-seekers for viewing by a hiring manager.

These and other features are discussed further below.

The data fusion subsystem 1000 may include a raw data repository or layer 1002 (“data lake”), a cleaning or pre-processing layer 1004, and a resulting combined database 1006. The raw data 1002 may include visual data 1008, textual data 1010, and other data 1012. Visual data 1008 may include images or video. Textual data 1010 may include digital profile data, resume items, peer recommendations, etc. Other data 1012 may include usage data, history data, social network inputs, outcome measures, etc.

Many of the data sources, such as the use of visual imagery, media links, and natural language comments and descriptions, may require pre-processing to be suitable for use in an analytical framework, especially in an automated way. As an example, the pre-processing layer 1004 may include a vision artificial intelligence (AI) module 1014 that automatically tags the visual input data 1008. The pre-processing layer 1004 may further include an NLP module 1016 that processes the textual input data 1010. The pre-processing layer 1004 may further include a metrics/validation module 1018 that computes proprietary summary metrics, and provides validation or other checks for numeric and categorical data.

The resulting combined database 1006 may store various processed data, such as image tags 1020, video tags 1022, processed text 1024 (e.g., stemmed, tokenized, etc., with order preserved), summary metrics 1026, numeric/categorical data 1028, outcome measures 1030, etc. The combined database 1006 may be accessed by the data analytics subsystem 1100 to allow the data analytics subsystem to perform various analytics, as discussed further below.

Data sources may include information directly supplied by job-seekers and employers, system usage data, feedback over time from job-seekers and employers, external data sources disclosed by users, etc. External data sources may require specific approval from users before data is accessed, and some sources may be more sensitive than others. Several non-limiting example external data sources that may be used by the augmented recruitment system are discussed below.

One external data source that may be used is LinkedIn or another business networking site. For example, a job-seeker may choose to supply a link to their LinkedIn profile to the augmented recruitment system. The public information on a LinkedIn profile may contain endorsements (e.g., keywords), references (e.g., written narratives), and other categories which may not be present on a submitted resume. The augmented recruitment system may process this information into a rich data set which is used for analysis or other action. For example, the augmented recruitment system may use NLP methods to scan the references to identify key concepts about the job-seeker. This may include keyword searches or a machine learning process which automatically identifies key concepts associated with successful job-seekers. Note that a concept might be more complicated than just the presence of a word or phrase, the concept may involve the order or absence of certain phrases, interaction with other attributes of the job-seeker, or attributes of the person writing the reference (e.g., whether they were a colleague or a supervisor).

Another data source may include background checks. This is a regulated area which generally requires specific permission from a job-seeker and clear disclosures about how the information will be used. Use of background check information can be very sensitive, and therefore in at least some instances may be avoided in predictive models.

Another data source may include social networks. As discussed briefly above, the augmented recruitment system may provide tools which allow a job-seeker to share their profile with friends or have friends comment or participate in constructing their profile. Apart from the data collected directly in this process, the augmented recruitment system may also examine public information of the friends who participate, subject to appropriate permissions. For example, an employee who likes their work experience at a particular company might help introduce their friends to that company when it is hiring.

Other data sources may include personal websites, portfolios, blogs, etc. When a job-seeker shares these resources with the augmented recruitment system, they provide extensive information in a very unstructured format. The augmented recruitment system may use NLP to scan this unstructured data and convert the data into usable metrics and key terms. The augmented recruitment system may be designed to focus specifically on job-relevant content to provide the most relevant results.

As shown in FIG. 11, the data analytics subsystem 1100 may input data from the combined database 1006 into one or more unsupervised learning modules 1102 or one or more supervised learning modules 1104 to generate results data 1106.

Non-limiting examples of unsupervised learning methods include clustering and classification, NLP, anomaly detection, principal component analysis (PCA), singular value decomposition (SVD), time series, imputation, hypothesis testing, etc. Clustering and classification methods may include hierarchical agglomerative, nearest neighbor, k-means (parametric), neural networks, support vector machine (SVM), regression-based methods (e.g., logistic regression, random forests), tree-based methods (e.g., classification and regression Trees (CART)), etc.

Non-limiting examples of supervised learning methods include prediction and classification, survival analysis, power analysis, etc. Example prediction methods include regression-based methods, neural networks, hidden Markov models, etc. In at least some instances, there may be overlap between supervised and unsupervised learning methods because it may be advantageous to predict attributes other than an overall outcome or single ranking summary for each candidate.

The results data 1106 may include, for example, ranked candidates for review by a recruiter or hiring manager, enhanced understanding of an applicant pool, identification of trends over time and across geographic regions, identification of key drivers of results, visualization or interpretation of structure in the data, etc.

The data analytics subsystem 1100 may provide insight to job-seeker credibility. Over time, a profile page showing milestones and badges from activity with the augmented recruitment system, as well as interests and social connections or activities, can convey credibility information regarding use of the augmented recruitment system. This information may be collected and archived for later analysis. Even with limited data, unsupervised clustering methods may be used to develop an understanding of the set of job-seekers and how they relate to job categories, specific jobs, or companies.

The augmented recruitment system may utilize outcome measures to examine how profile elements relate to desired outcomes. Outcome measures may take the form of feedback from companies or ranking systems involving employers and/or peers. Although in at least some implementations multiple measures may be combined into a single rank number (e.g., a “score”), this may not be a useful summary of a job-seeker. Thus, in at least some implementations, a profile summary may be presented which conveys a significant amount of information about a job-seeker.

The profile summary page for a candidate may present statistics and other information about a candidate over the course of their history using the augmented recruitment system. The profile summary page may be divided into two areas of information, a user stats and milestones/badges area, and a user social likes area.

The user statistics and milestones area may include some or all basic information obtained or calculated from a candidate based on their usage history. This may include information that is collectable immediately, such as the number of times the candidate is selected by an employer, the last sign-in, the number of months active, how many jobs the candidate has applied or been hired for, social links, profile views, etc. The information may also include information that is collectible over time, such as how long the candidate remains at a job, the number of friends that view or “like” the candidate's profile, interview feedback, post-hiring feedback (e.g., 3 month feedback, 1 year feedback), etc.

The user social likes area of the profile summary page may include the candidate's social likes and dislikes, which may be obtained by asking the candidates directly or by analyzing received data indicative of such. For example, a candidate's social likes and dislikes may be asked of them as optional data that can be filled out on their profile page. Examples of social likes include whether the candidate likes dogs, outdoors, animals, sports, music, etc.

The augmented recruitment system may capture various user data for analysis including, for example, standard date/time stamps, geo-location stamps, login data, jobs applied for, profile edits, etc. The augmented recruitment system may also capture various organization data for analysis including, for example, company driven events (e.g., profile shares, selected candidates, saved candidates, candidates not selected, resumes downloaded, likes, job creations, jobs updated), company driven behavior (e.g., time on screen for each page or event, capturing relevant screen information, behavior when selecting or passing on a candidate), etc.

Unsupervised clustering methods allow insight into natural groupings in the data. The augmented recruitment system may use such methods to explore how particular profile elements are related to different job categories. The system may also use anomaly detection (or fraud detection) methods to identify job-seekers or jobs which stand out in some way.

The augmented recruitment system may use ranking methods to match up competitors of similar skill levels in a game setting. In a customer service setting, ranking methods can combine ratings in a way that is robust to outliers (e.g., tempering the impact of an occasional bad day) or which draws extra scrutiny to anomalies. Predictive models may be used to compare a job-seeker to previous job-seekers with known outcomes, which allows generation of rankings for who is likely to have a good outcome. This may be tailored to a particular job category or employer.

The augmented recruitment system may use recommendations and peer reviews as part of a credibility assessment. The content of these narratives may be analyzed using NLP, which allows for decomposition of the narrative into a set of elements which can form a foundation for clustering methods and predictive models.

The data analytics subsystem 1100 may also provide insight into job-seeker soft skills. As discussed above, it is difficult to quantitatively assess soft skills such as reliability, professionalism, focus, courtesy, teamwork, etc. This is a key pain point for hiring professionals who know the importance of these skills but lack a way to assess or quantify them. The augmented recruitment system may use data science to solve this problem by surfacing consistent mentions or signifiers of soft skills in unstructured data, such as recommendations written for a job-seeker, narratives written by the job-seeker, or external data supplied by the job-seeker such as blogs or profiles on other sites. When an appropriate data set is available, the system may also look for quantitative predictors which are associated with good soft skills outcomes.

The system may initially generate a list of terms related to soft skills, which provides a target space to use with NLP tools. As an example, the system may use regular expressions to scan through available data and then apply unsupervised clustering methods. Then, the system may use Term-Frequency and Inverse Document Frequency (TF, IDF, and TF/IDF) analysis to examine the term list in the context of unstructured data sets. This approach also allows for automatically identifying new key terms related to soft skills.

When outcome measures are available, the system may use the same foundation of key terms in predictive models based on regression, neural nets, or other approaches.

The data analytics subsystem 1100 may provide insight to commonalities and differences between job-seekers and between jobs. One key value of the augmented recruitment system in the HR ecosystem is the ability to view data across many job-seekers and job positions. The augmented recruitment system provides insight to both companies and job-seekers by mining available data for common themes across job-seekers. For example, augmented recruitment system may see that applicants for viticulture jobs in the state of Washington are 90 percent male, and 60 percent have a two-year college degree. Descriptive data on who is actually hired for these jobs may also be provided. This information may be useful for a company when they think about how they do recruiting and outreach. It can also be useful for a job-seeker to understand the industry and to decide what to emphasize about themselves as they prepare for interviews.

Similarly, the augmented recruitment system may show how a job-seeker differs or stands out from the crowd. For example, suppose a job-seeker for an accounting job has background as a paralegal. This is somewhat unusual, and by automatically picking up on this unusual detail, the augmented recruitment system can help the hiring manager quickly see how this job-seeker is unique. This feature may be a useful dashboard for the job-seeker as well, to see areas where they might stand out for a particular job.

To achieve this, a large and useful set of key concepts to detect and measure may be defined and automatically detected and collected. Such data may include, for example, basic demographics like age, gender, and education level, and relevant categories of past work experience. NLP methods may be used to automatically identify new key concepts from a growing database of resumes and job postings, which may be combined with customer usage data, such as terms that are used in searches.

The data analytics subsystem 1100 may also provide evolving methods for building a personal connection between companies and job-seekers. As data accumulates regarding outcomes based on the use of the augmented recruitment system, the captured data may be analyzed to determine which are contributing the most to good outcomes and which are not. This analysis, along with qualitative feedback from users, functions to improve the augmented recruitment system over time. Depending on the kind of data available about outcomes, the augmented recruitment system may use a regression-based approach or other predictive models to assess the impact of each element of the augmented recruitment system.

Although embodiments described above are primarily directed to job seekers or current employees, embodiments are not so limited. Rather embodiments described herein can be used to assess compatibility for personal or romantic relationships, education, and other avenues.

For example, in the relationship context, people looking for a romantic relationship are provided a plurality of attributes. These users can select content that they believe best fits the attribute or that best describes their position or believe about the attribute. Embodiments described herein can tag or label the content, which is then used to generate a personality profiles for the users. Use of various data analytics, artificial intelligence models, or machine learning mechanisms can be used to correlate and introduce similar-minded users.

In the education context, prospective students can generate personality profiles, as described herein, which can be provided to universities or other educational institutions. These institutions can utilize metrics and other information from the profiles as part of the student-selection criteria, similar to an employer hiring new employees. Students can also utilize embodiments described to find funding or roommates. Typically, new students are assigned a roommate. Some institutions utilize the new student's major or hometown information to assign roommates. By employing embodiments described herein, however, new students can be matched based on their personality, which can result stronger bonded roommates.

FIG. 12 is a block diagram of an example processor-based device 1200 that may be used to implement at least a portion of the augmented recruitment system 102 or other system discussed herein (e.g., organization system 104, candidate system 106, content system 108). The processor-based device 1200 is able to read instructions from a processor-readable medium (e.g., nontransitory processor-readable storage medium) and perform any of the functionality discussed herein. The processor-based device 1200 may operate as a standalone device or may be coupled or networked to other devices. In a networked environment, the processor-based device 1200 may operate as a server device or a client device, or as a peer device in a peer-to-peer network environment. The processor-based device 1200 may comprise, for example, a server computer, a client computer, a personal computer, smartphone, a wearable computer, a tablet computer, a personal digital assistant (PDA), a laptop computer, a desktop computer, a game console, a set-top box, etc., or any of one or more devices capable of implementing the functionality described herein.

The processor-based device 1200 may include one or more processors 1202, memory 1204, and input/output (I/O) components 1206, which communicate with each other via a bus 1208. The processors 1202 may include one or more of a central processing unit (CPU), a graphics processing unit (GPU), a digital signal processor (DSP), an application specific integrated circuit (ASIC), another processor, or any suitable combination thereof. The processors 1202 may include a single processor, or a plurality of processors 1210 that execute instructions 1212. The processors 1202 may include multi-core processors that may include two or more independent processors (“cores”) that can execute instructions 1212 concurrently.

The memory 1204 may include a primary storage 1214 and a secondary storage 1216. The primary storage 1214, which may also be referred to as main memory or internal memory, may be directly accessible by the processors 1202. Non-limiting examples of the primary storage 1214 include random-access memory (RAM), read-only memory (ROM), buffer memory, flash memory, cache memory, etc. The secondary storage 1216 may include memory that is not directly accessible by the processors 1202. Non-limiting examples of the secondary storage 1216 may include solid-state memory (e.g., flash memory), optical media, magnetic media, other non-volatile memory (e.g., programmable read-only memory (PROM), or any suitable combination thereof. More generally, the primary storage 1214 and the secondary storage 1216 may include one or more nontransitory processor-readable storage media that store at least one of instructions or data that may be accessed by the processors 1202 to implement the functionality described herein. The storage 1214 and 1216 may be individual components or may include a plurality of components, and may be local, remote (e.g., cloud-based storage systems or networks), or any combination thereof.

The I/O components 1206 may include various combinations of input components 1218, output components 1220, sensors 1222, and communications components 1224, to receive input, provide output, transmit information, exchange information, capture information, etc. The I/O components 1206 may include additional or fewer components than are illustrated in FIG. 12.

The input components 1218 may include key input components (e.g., keyboard, touchscreen), point-based components (e.g., mouse, touchpad, trackball, joystick, motion sensor), tactile input components (e.g., buttons, sliders), audio input components (e.g., microphone), or other input components.

The output components 1220 may include visual components (e.g., display, projector), acoustic components (e.g., speaker), haptic components (e.g., vibrating motor), or other output components.

The sensors 1222 may include various types of sensors, including biometric sensors (e.g., gesture sensors, heart rate sensors), motion sensors (e.g., accelerometer, gyroscope), environmental sensors (e.g., illumination sensor, temperature sensor), position sensors (e.g., global positioning system (GPS) sensor), or other sensors.

The communications components 1224 may include a variety of communication technologies that operate to communicatively couple the processor-based device 1200 to a network 1226 or external devices 1228. For example, the communications components 1224 may include a network interface component or other suitable device to interface with the network 1226. The communications components 1224 may include wired communications components, wireless communications components, or combinations thereof. Non-limiting examples of wired communications include FireWire®, Universal Serial Bus® (USB), Thunderbolt®, Gigabyte Ethernet®, or any other suitable wired connection. Non-limiting examples of wireless communications include Bluetooth®, Wi-Fi®, Zigbee®, NFC (Near-field communication), cellular (e.g., 4G, 5G, etc.), RFID, or any suitable wireless connection.

The network 1226 may be any communication network or part thereof, such as an ad hoc network, the Internet, an extranet, a virtual private network (VPN), a local area network (LAN), a wide area network (WAN), a public switched telephone network (PSTN), a plain old telephone service (POTS) network, a cellular network, another type of network, or any combination of networks that allows for communication between devices.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, including U.S. Provisional Patent Application Ser. No. 62/846,373, filed May 10, 2019, are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

Accordingly, the claims are not limited by the disclosure.

1-20. (canceled)

21. An augmented recruitment system, comprising:
a database configured to store a plurality of digital candidate-personality profiles for a plurality of users;
an output interface configured to display a graphical user interface to a target user; and
a processor configured to execute computer instructions to:
present, via the graphical user interface and to the target user, a plurality of personality attributes;
receive, via the graphical user interface and from the target user, content for each corresponding attribute of the plurality of personality attributes, wherein the received content includes one or more of: visual content and audio content;
generate a digital candidate-personality profile for the target user based on the received content and a personality attribute associated with the content for each of the plurality of personality attributes by applying the content and the personality attribute to a machine learning model trained to generate a content score based on content and a personality attribute; add the generated digital candidate-personality profile to the plurality of digital candidate-personality profiles;
access unstructured data related to the target users;
determine, based on the unstructured data and the plurality of digital candidate-personality profiles, one or more identifiers of one or more personality attributes; and
re-train the machine learning model based on the one or more identifiers.

22. The augmented recruitment system of claim 21, wherein the processor executes further computer instructions to:
receive additional content regarding a position within an organization, the additional content including content automatically obtained from one or more sources of information related to the organization;
determine, based on the additional content, one or more threshold content scores for a plurality of personality attributes by applying the additional content and the personality attributes to the machine learning model;
determine, based on the digital candidate-personality profile and the threshold content scores, whether the user should be a candidate for the position; and
cause the digital candidate-personality profile to be transmitted to a computing device associated with the organization based on the determination of whether the user should be a candidate for the position.

23. The augmented recruitment system of claim 21, wherein the processor receives the content by executing further computer instructions to:
receive, for a select attribute of the plurality of personality attributes, textual content that is representative of the target user's affinity for the select attribute.

24. The augmented recruitment system of claim 21, wherein the processor receives the content by executing further computer instructions to:
receive, for a select attribute of the plurality of personality attributes, audio content that is representative of the target user's affinity for the select attribute.

25. The augmented recruitment system of claim 21, wherein the processor receives the content by executing further computer instructions to:
present, via the graphical user interface and to the target user, a plurality of content options associated with a select attribute of the plurality of personality attributes; and
receive, via the graphical user interface and from the target user, a visual content selection from the plurality of content options that is representative of the user's affinity for the select attribute.

26. The augmented recruitment system of claim 21, wherein the processor executes further computer instructions to:
receive, from the target user and destined for a target organization, a job application for a job posting by the target organization;
augment the job application to include the digital candidate-personality profile for the target user; and
forward the augmented job application to the target organization.

27. The augmented recruitment system of claim 21, wherein the processor executes further computer instructions to:
prior to the presentation of the plurality of personality attributes to the target user via the graphical user interface:
receive, from the target user and destined for a target organization, a job application for a job posting by the target organization;
query the database for the digital candidate-personality profile associated with the target user;
responsive to an empty query result, present, via the graphical user interface and to the target user, the plurality of personality attributes; and
responsive to the generation of the digital candidate-personality profile for the target user:
augment the job application to include the digital candidate-personality profile for the target user; and
forward the augmented job application to the target organization.

28. A method of operating a computing system, comprising:
storing a plurality of digital user-personality profiles for a plurality of users in a team, wherein each digital user-personality profile for each target user is generated by:
presenting, via a graphical user interface and to the target user, a plurality of personality attributes;
receiving, via the graphical user interface and from the target user, content for each corresponding attribute of the plurality of personality attributes, wherein each received content represents the target user's personality for the corresponding attribute, and wherein each received content includes one or more of: visual content and audio content;
receiving, via the graphical user interface and from the target user, team information associated with the target user; and
generating the digital user-personality profile for the target user based on the received content and a personality attribute associated with the received content for each of the plurality of personality attributes and the received team information by applying the received content and the personality attribute to a machine learning model trained to generate a content score based on content and team information;
generating a digital team-personality profile for the team based on the plurality of user-personality profiles;
adding the generated digital team-personality profile to a plurality of digital team-personality profiles;
accessing unstructured data related to the plurality of users;
determining, based on the unstructured data and the plurality of digital team-personality profiles, one or more identifiers of one or more personality attributes; and
re-training the machine learning model based on the one or more identifiers.

29. The method of claim 28, further comprising:
generating at least one metric among the plurality of users of the team based on the digital team-personality profile; and
presenting the at least one metric to the user.

30. The method of claim 29, wherein generating the at least one metric further comprises:
identifying one or more correlations between team members based on a comparison of the received content provided by each team member.

31. The method of claim 28, wherein receiving the team information includes:
receiving a role of the target user and an identifier of the team associated with the target user.

32. The method of claim 28 further comprising:
receiving additional content regarding an objective of the team, the additional content including content automatically obtained from one or more sources of information related to an organization associated with the team;
determining, based on the additional content, one or more threshold content scores for a plurality of personality attributes by applying the additional content and the personality attributes to the machine learning model;
determining, based on the digital team-personality profile and the threshold content scores, whether the user should be a member of the team; and
altering the user's membership on the team based on the determination of whether the user should be a member of the team.

33. The method of claim 28, wherein receiving the content further comprises:
receiving, for a select attribute of the plurality of personality attributes, textual content that is representative of the target user's affinity for the select attribute.

34. The method of claim 28, wherein receiving the content further comprises:
receiving, for a select attribute of the plurality of personality attributes, audio content that is representative of the target user's affinity for the select attribute.

35. The method of claim 28, wherein receiving the content further comprises:
presenting, via the graphical user interface and to the target user, a plurality of content options associated with a select attribute of the plurality of personality attributes; and
receiving, via the graphical user interface and from the target user, a visual content selection from the plurality of content options that is representative of the target user's affinity for the select attribute.

36. A nontransitory processor-readable storage medium that stores computer instructions that, when executed by at least one processor, cause the at least one processor to:
generate a plurality of digital candidate-personality profiles for a plurality of users, wherein each digital candidate-personality profile is generated including:
present a plurality of personality attributes to a target user;
receive content for each corresponding attribute of the plurality of personality attributes from the target user, wherein each received content includes one or more of: visual content and audio content; and
generate a digital candidate-personality profile for the target user based on the received content and a personality attribute associated with the content for each of the plurality of personality attributes by applying the content and the personality attribute to a machine learning model trained to generate a content score based on content and a personality attribute; and
access unstructured data related to the plurality of users;
determine one or more identifiers of one or more personality attributes based on the unstructured data and the plurality of digital candidate-personality profiles; and
re-train the machine learning model based on the one or more identifiers.

37. The nontransitory processor-readable storage medium of claim 36, wherein the computer instructions further cause the at least one processor to:
receive additional content regarding a position within an organization, the additional content including content automatically obtained from one or more sources of information related to the organization;
determine one or more threshold content scores for a plurality of personality attributes by applying the additional content and the personality attributes to the machine relaxing model;
determine whether at least one user of the plurality of users should be a candidate for the position based on the digital-candidate personality profile for the at least one user and the threshold content scores; and
cause the digital-candidate personality profile for the at least one user to be transmitted to a computing device associated with the organization based on the determination of whether the user should be a candidate for the position.

38. The nontransitory processor-readable storage medium of claim 36, wherein the computer instructions, when executed by the at least one processor to receive the content, further cause the at least one processor to:
receive, for a select attribute of the plurality of personality attributes, textual content that is representative of the target user's affinity for the select attribute.

39. The nontransitory processor-readable storage medium of claim 36, wherein the computer instructions, when executed by the at least one processor to receive the content, further cause the at least one processor to:
receive, for a select attribute of the plurality of personality attributes, audio content that is representative of the target user's affinity for the select attribute.

40. The nontransitory processor-readable storage medium of claim 36, wherein the computer instructions, when executed by the at least one processor to receive the content, further cause the at least one processor to:
present, via the graphical user interface and to the target user, a plurality of content options associated with a select attribute of the plurality of personality attributes; and
receive, via the graphical user interface and from the target user, a visual content selection from the plurality of content options that is representative of the target user's affinity for the select attribute.
